(19) United States
(12) Patent Application Publication
(10) Pub. No.: US 2024/0119143 A1
(43) Pub. Date: Apr. 11, 2024

(54) A HYPER-SCALE CLOUD ENVIRONMENT STANDARD CONTROL DEVIATION REMEDIATION APPLICATION

(71) Applicant: Lorenzo MODESTO, Chatswood (AU)

(72) Inventor: Lorenzo MODESTO, Chatswood (AU)

(21) Appl. No.: 18/263,859

(22) PCT Filed: Mar. 3, 2022
(86) PCT No.: PCT/AU2022/050173

§ 371 Date: Aug. 1, 2023

(30) Foreign Application Priority Data
Mar. 4, 2021 (AU) 2021900602

(51) Int. Cl. G06F 21/55; G06F 40/40

(52) U.S. Cl. CPC G06F 21/554; G06F 40/40; G06F 2221/034

(57) ABSTRACT

An application installable in a hyper-scale cloud environment has a remediation playbook comprising at least one remediation having at least one action for a standard control. The application serves a configuration interface for configuring a response level and a listener. In use, the application receives an alert from a SIEM of the Hyper-scale cloud environment, identifies the remediation using the alert and implements the action of the remediation depending on the response level.

### FIELD OF THE INVENTION

This invention relates generally to application installable in a hyper-scale cloud environment for automated control deviation remediation.

### BACKGROUND OF THE INVENTION

Best practices standards comprise a series of controls for determining deviation from best practices. These standards include the Center for Internet Security (CIS), Payment Card Industry Data Security Standard (PCI DSS) and Amazon™ Web Services (AWS) Foundational Security Standards.

For example, the AWS Foundational Security Best Practices standard comprises controls that specify when deployed accounts and resources deviate from security best practices and can be used for continuous evaluation of AWS accounts and workloads to quickly identify areas of deviation from best practices.

Hyper-scale cloud environment infrastructure may comprise Security Information and Event Management (SIEM) which is a set of tools and services offering a holistic view of an organization's information security. SIEM tools provide real-time visibility across an organization's information security systems and event log management that consolidates data from numerous sources.

It is to be understood that, if any prior art information is referred to herein, such reference does not constitute an admission that the information forms part of the common general knowledge in the art, in Australia or any other country.

### SUMMARY OF THE DISCLOSURE

There is provided herein an application which is installable within a hyper-scale cloud environment, such as AWS. The application comprises a remediation playbook that is a single, authoritative library used to automatically remediate controls (for which remediation can be automated) across various standards, preferably at least three standards being CIS, PCI-DSS and AWS Foundational Security Standard.

The playbook is referenced by the application when alerted by an SIEM platform (such as AWS Security Hub) to automatically remediate controls when deviation is detected therefrom.

The application may comprise a webserver serving a configuration interface for configuring a control response level and a listener which receives alerts from the SIEM, identifies the remediation and implements the action depending on the response level. Response levels may comprise a “soft” response wherein automated alerts are generated, including a series of escalating alerts. Furthermore, response levels may comprise an automatic response wherein the application automatically implements the remedial action.

For example, the listener may receive an alert that an application is accessible via port 22 from anywhere on the Internet wherein the playbook remediation action takes the step of automatically closing port 22.

The application may monitor the success or failure of the action and take additional steps, such as by generating further alerts and/or implementing further actions if an action fails. In embodiments, the application may further comprise reverse playbooks associated with respective playbooks which can undo problematic actions.

Other aspects of the invention are also disclosed.

### BRIEF DESCRIPTION OF THE DRAWINGS

Notwithstanding any other forms which may fall within the scope of the present invention, preferred embodiments of the disclosure will now be described, by way of example only, with reference to the accompanying drawings in which:

FIG. 1 shows a Hyper-scale cloud environment having an application installable therein for standard control deviation remediation in accordance with an embodiment;

FIG. 2 illustrates an exemplary playbook in accordance with an embodiment; and

FIG. 3 illustrates exemplary processing involving the application in accordance with an embodiment.

### DESCRIPTION OF EMBODIMENTS

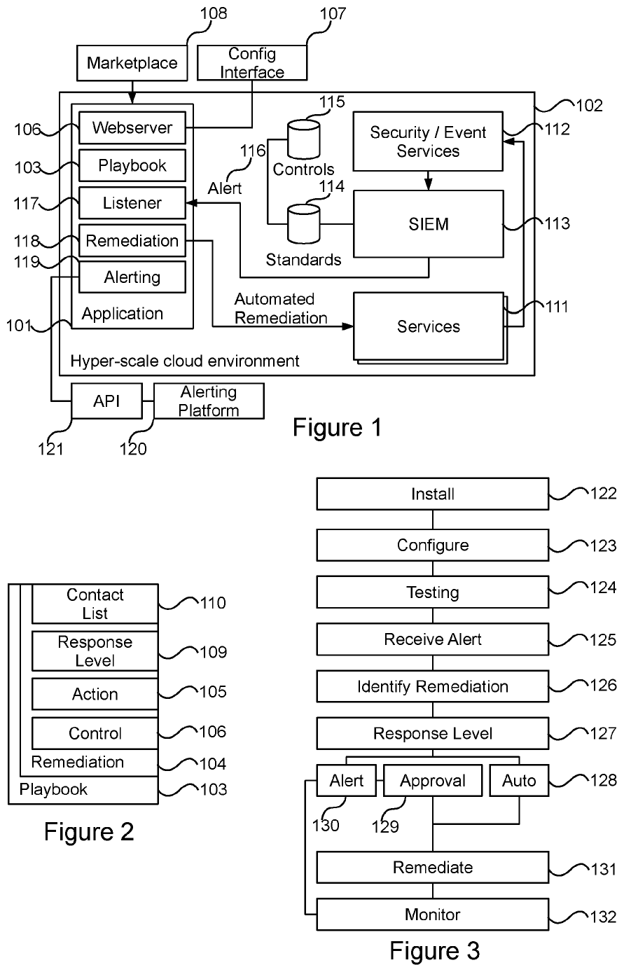

FIG. 1 shows an application 101 installable in a hyper-scale cloud environment 102 such as AWS. The application 101 may be downloaded from an app marketplace 108. The application 101 comprises a remediation playbook 103 comprising at least one remediation 104 as shown in FIG. 2. The remediation 104 has at least one action 105 for a referenced control 106. For example, the action 105 may open or close support, adjust a viewing permission setting, verify or restore a backup and the like.

The referenced control 106 references a control 115 of a standard 114. The standard 114 may be an international standard such as PCI-DSS, ISO 27001 or SOC 2.

The application 101 may comprise a webserver 106 which serves a configuration interface 107. The configuration interface 107 may be used for configuring a response level 109 of the remediation 104, configuring a contact escalation list 110 and more.

The hyper-scale cloud environment 102 implements a number of services 111 such as simple storage services (such as Amazon S3). The environment 102 further comprises security and event services 112 which interface the services 111 and Security Information and Event Management (SIEM) 113.

The SIEM 113 references a plurality of standards 114, each having a plurality of controls 115 therein to generate an alert 116 when deviation from a control 115 is detected using information received from the security and event services 112.

The application 101 comprises a listener 117 which receives alerts 116 from the SIEM 113. The application 101 comprises a remediation controller 118 for implementing remediations 104 and an alerting controller 119 for generating alerts. The alerting controller 119 may interface an alerting platform 120 via an API 121.

FIG. 3 illustrates installation of the application 101 at step 122 wherein the application 101 is purchased and downloaded from the marketplace 108 and installed in the hyper-scale cloud environment 102 according to best practices.

The application 101 comprises the remediation playbook 103 which may reference controls 115 of a plurality of standards 114.

Step 123 comprises configuration of the application wherein the user uses the configuration interface 107 exposed by the webserver 106 of the application 101.

Using the configuration interface 107, the user can configure a response level 109 for each control 106.

The response level 109 may comprise levels including ‘automatic’ wherein a corresponding action 105 is automatically implemented, ‘alert’ wherein an alert is generated by the alerting controller 119 and ‘approval’ wherein approval is sought whereafter the action 105 is implemented only after receiving an approval response.

The playbook 103 may comprise a defined action 105 for each referenced control 106. Alternatively, the user may choose one or more actions 105 for each referenced control 106 using the configuration interface 107.

At step 124, the application 101 may be configured to allow for testing one or more actions 105 of the application 101 such as by implementing an action 105 (i.e. roll forward), observing the results (i.e. the success or failure thereof) and rollback of the remediation if it has been observed to cause negative collateral impact to the environment's function, performance or availability. For example, an action 105 may specify the closing of port 22 in a Security Group. However, if once implemented by the application 101 (i.e. rolled forward) it is observed that access via 22 across the Internet is required, the application 101 may be rolled back to undo the action, to thereby open the port again.

At step 125, the listener 117 receives an alert 116 from the SIEM 113.

For example, the security and event services 113 may detect that an S3 bucket is publicly accessible, thereby deviating from a control 115 of the AWS™ Foundational Security Standard™ 114.

The alert 116 generated by the SIEM 113 may identify the control 115 and the bucket.

The remediation controller 118 identifies the control 115 from the alert 116 using the referenced control 106 and identifies the appropriate remediation 104 from the playbook 103 by the referenced control 106 thereof.

The remediation controller 118 then references the configured response level 109 thereof.

The response level 109 may be ‘alert’ (i.e., soft response) wherein, at step 130, the remediation controller 118 causes the alerting controller 119 to generate an alert. The alert may be transmitted via one or more alerting platforms 120.

The alerting controller 119 may generate a plurality of alerts according to the contact escalation list 110.

In one manner, the alerting controller 119 uses time period escalation wherein alerts are escalated depending on the time duration of the deviation from the control 115. In another manner, the alerting controller 119 escalates alert until receiving an acknowledgement.

The response level 109 may be ‘approval’ wherein, at step 129, the remediation controller 119 requests approval and only implements the action 105 when receiving an approval response. The approval response may be received in a number of manners, such as by way of a web interface, response to an alert and the like.

In further embodiments, the response level 109 may be a ‘once off’, which implements a remedial action once only, rather than in an automated and ongoing basis

The response level 109 may be ‘automatic’ wherein, at step 128, the remediation controller 118 automatically implements the action 105 at step 131.

In accordance with the present example, the action 105 may comprise changing the viewing permission settings of the identified bucket to private.

Step 132 may comprise the remediation controller 118 monitoring the success or failure of the action 105.

If the action fails 105, the remediation controller 118 may send an alert at step 130. Alternatively, the remediation controller 118 may implement another action 105.

In embodiments, the application 101 need not necessarily generate an alert or implement a remediation for a control deviation but rather update a log file or report the deviation thereof for information purposes only.

In embodiments, various playbook automation safeguards may be implemented per control.

For example, according to one aspect, the application 101 may generate alerts until such time that a user has remediated each deviation.

According to a further aspect, playbooks 103 (or remediations 104) may be categorised as intrusive or nonintrusive. For example, non intrusive playbooks 103 cannot impact the performance or availability of an application because, for example, they may only generate alerts or logs. Conversely, intrusive playbooks 103 may affect the performance or availability of an application (such as by opening or closing ports) and therefore may be required to be evaluated by a user prior enablement. The interface 107 may allow grouping of these playbooks 103 by the user.

According to yet further aspect, the application 101 may retrieve and present remediation documentation via the configuration interface 107, especially if the user wishes to perform the remediation manually.

According to another aspect, the interface 107 may provide a link directly to an incident in the SIEM platform 113.

In another aspect, the application 101 may allow a user to remediate each deviation individually. For example, there may be multiple misconfigurations in one AWS service requiring remediation.

In accordance with a further aspect, the application 101 may be configured with a reverse playbook 103 which reverses a configuration of an associated playbook 103, such as reopening a port that has been closed.

In embodiments, the reverse playbook 103 may store (such as by scraping) an application configuration so that after the remediation has been performed by a playbook 103, the reverse playbook 103 may reinstate the original configuration if problems relating to performance or availability of an application occur. In embodiments, the reverse playbook 103 may perform partial remediation reversals wherein, for example, the reverse playbook 103 only reconfigures ports if it is detected that only port configuration is problematic whilst not reconfiguring an IP address configuration if the IP address configuration is not problematic.

In embodiments, a reverse playbook 103 may be configured by the configuration interface 107, API the like.

In embodiments, the application 101 is configured for converting natural language remediation instructions into playbooks 103 using natural language processing, a rules engine, service API libraries and/or playbook templates.

For example, a natural language remediation instruction may comprise the sentence “Navigate to a URL that manages the configuration of an S3 bucket, select the noncompliant bucket, choose the bucket name, choose Permissions, choose the Bucket Policy, add the new policy statement and apply the new configuration.” As such, natural language processing may be used to infer meaning from this sentence to generate a playbook 103 or action 105 accordingly.

Conversely, if the natural language remediation is written in a standard fashion, such as always using the same verb and noun structure (“NAVIGATE to a URL, CHOOSE a SETTING, APPLY the SETTING”) then the conversion may not require natural language processing and simpler forms of string matching such as regular expression matching may be used.

In embodiments, the application 101 may prompt a user via the configuration interface 107 to verify or provide any additional information as may be required when converting natural language remediation instructions to playbooks 103 and/or actions 105. For example, the application 101 may prompt the user to provide or select a bucket.

When converting natural language remediation instructions into playbooks 103, the application 101 may reference other playbooks 103 and natural language instructions associated therewith to identify configuration setting structures and create playbooks directly from the remediation instructions.

In embodiments, playbooks 103 may be combined in a suit of protective anti-ransomware measures to allow a user to automatically protect, detect and recover from a ransomware attack. For example, playbook 103 may be configured to protect against ransomware by ensuring that an application is continually compliant with cloud security best practice controls.

Furthermore, a playbook 103 may detect if there is a deviation from best practice (such as a publicly accessible S3 bucket) and takes remediation steps as outlined above, including automatic implementation, alerting and the like.

Furthermore, a playbook 103 may be used to recover from irretrievable ransomware compromise wherein the playbook 103 periodically automatically tests the making or retrieval of backups and/or automatically reinstates a backup copy if an application has been encrypted in a ransomware attack.

In embodiments, the application 101 may be configured with mappings between controls 104 of different standards 114. For example, port mapping configurations of the Amazon™ Web Services (AWS) Foundational Security Standards may have knock-on effects of controls 103 relating to the Payment Card Industry Data Security Standard (PCI DSS). As such, by mapping controls 104, the application 101 may allow for automatic and continuous compliance with multiple standards without the need for human intervention.

The foregoing description, for purposes of explanation, used specific nomenclature to provide a thorough understanding of the invention. However, it will be apparent to one skilled in the art that specific details are not required in order to practise the invention. Thus, the foregoing descriptions of specific embodiments of the invention are presented for purposes of illustration and description. They are not intended to be exhaustive or to limit the invention to the precise forms disclosed as obviously many modifications and variations are possible in view of the above teachings. The embodiments were chosen and described in order to best explain the principles of the invention and its practical applications, thereby enabling others skilled in the art to best utilize the invention and various embodiments with various modifications as are suited to the particular use contemplated. It is intended that the following claims and their equivalents define the scope of the invention.

1. An application installable in a hyper-scale cloud environment, the application comprising a remediation playbook comprising at least one remediation having at least one action for a standard control, a configuration interface for configuring a response level and a listener which, in use, receives an alert from a SIEM of the Hyper-scale cloud environment, identifies the remediation using the alert and implements the action of the remediation depending on the response level—wherein the application is configured for:
sentence structure string matching to convert natural language remediation instructions to playbook actions, whereby verbs and nouns identified from the natural language remediation instructions by the using sentence structure string matching are converted into actions and settings respectively; and
prompting a user via the configuration interface to provide a setting for at least one converted playbook action, wherein the application further comprises a reverse playbook associated with the playbook and wherein the application is configured for ascertaining an application configuration and configuring the reverse playbook accordingly to restore an application according to the application configuration after implementation of the playbook, further comprising a further remediation playbook and mappings between controls of the remediation playbook and the further remediation playbook so that, when an action of the remediation playbook is implemented, an associated action of the further remediation playbook is identified using the mapping and subsequently implemented.

2. The application as claimed in claim 1, wherein the response level is automatic wherein the application automatically implements the action.

3. The application as claimed in claim 1, wherein the response level is alert wherein the application generates an alert.

4. The application as claimed in claim 3, wherein generating the alert comprises interfacing an alerting platform via an API.

5. The application as claimed in claim 4, wherein generating the alert comprises generating a series of alerts using an escalated contact list.

6. The application as claimed in claim 1, wherein the response level as approval wherein the application receives an approval response prior implementing the action.

7. The application as claimed in claim 1, wherein the application monitors the implementation of the action to determine if the action fails.

8. The application as claimed in claim 7, wherein the application generates an alert if the action fails.

9. The application as claimed in claim 7, wherein the application implements a further action if the action fails.

10. The application as claimed in claim 1, wherein the standard is CIS.

11. The application as claimed in claim 1, wherein the standard is PCI-DSS

12. The application as claimed in claim 1, wherein the standard is AWS' Foundational Security Standard™.

13. The application as claimed in claim 3, wherein the application generates alerts until each alert is remediated.

14. The application as claimed in claim 1, wherein at least one of the playbook and the at least one remediation is categorised as intrusive or nonintrusive depending on its effect on performance or availability of an application.

15. The application as claimed in claim 1, wherein the interface retrieves and displays remediation documentation associated with the alert.

16. (canceled)

17. The application as claimed in claim 1, wherein the playbook comprises an action to close a port and the reverse playbook comprises an action to open the port.

18. (canceled)

19. The application as claimed in claim 1, wherein the reverse playbook is configured to partially restore the application configuration.

20. (canceled)

21. (canceled)

22. (canceled)

23. The application as claimed in claim 1, wherein the application is configured for referencing other playbooks and natural language instructions associated therewith to identify configuration setting structures when converting the natural language remediation instructions into the playbook actions.

24. The application as claimed in claim 1, wherein the playbook periodically implements the at least one action.

25. The application as claimed in claim 24, wherein the at least one action at least one of makes and tests a backup.

26. The application as claimed in claim 1, wherein the at least one action automatically restores a backup.

27. (canceled)
